(19) United States
(12) Patent Application Publication
(10) Pub. No.: US 2011/0001951 A1
(43) Pub. Date: Jan. 6, 2011

(54) LITHOGRAPHIC APPARATUS AND METHOD

(75) Inventor: Hans Butler, Best (NL)

Correspondence Address: PILLSBURY WINTHROP SHAW PITTMAN, LLP, P.O. BOX 10500, MCLEAN, VA, 22102, US

(73) Assignee: ASML Netherlands B.V., Veldhoven (NL)

(21) Appl. No.: 12/920,799

(22) PCT Filed: Mar. 2, 2009
(86) PCT No.: PCT/NL09/00050

§ 371 Date: Sep. 2, 2010

Related U.S. Application Data
(60) Provisional application No. 61/064,431, filed on Mar. 5, 2008.

(51) Int. Cl. G03B 27/54; G05B 11/06

(52) U.S. Cl. 355/67; 318/635; 318/560

(57) ABSTRACT

A drive system for controllably driving an electric actuator includes a current sensor system to sense a current conducted by the actuator and a driver to electrically drive the actuator based on an output signal of the current sensor system. The current sensor system includes at least a first and a second %forwardcurrent sensor that have a mutually different sensitivity for the current to be sensed and the drive system includes a current sensor controller to control an extent to which each of the current sensors to determine the output signal of the current sensor system.

### CROSS-REFERENCE TO RELATED APPLICATIONS

This application claims the benefit of U.S. provisional application 61/064,431, which was filed on 5 Mar. 2008, and which is incorporated herein in its entirety by reference.

### FIELD

The present invention relates to lithographic apparatus and method.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. including part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Conventional lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

For the sake of simplicity, the projection system may hereinafter be referred to as the “lens”; however, this term should be broadly interpreted as encompassing various types of projection system, including refractive optics, reflective optics, and catadioptric systems, for example. The radiation system may also include components operating according to any of these design types for directing, shaping or controlling the projection beam of radiation, and such components may also be referred to below, collectively or singularly, as a “lens” or “projection system”.

To project the pattern on the substrate, it is desirable that the patterning device and the substrate be accurately aligned, i.e. positioned with respect to each other. Further, the patterning device and the substrate may need to be aligned with respect to the radiation beam and/or other devices that are included in the lithographic apparatus.

In conventional lithographic apparatus, both the substrate table and the pattern support are provided with an actuator assembly that is configured to accurately position the substrate and the patterning device with respect to a reference point. The actuator assembly may include a long stroke actuator and a short stroke actuator. The long stroke actuator and the short stroke actuator are operatively coupled to enable to move the substrate or patterning device over a relatively large distance using the long stroke actuator and to accurately position the substrate or patterning device using the short stroke actuator. It is noted that an actuator for moving an object over a large distance, such as the long stroke actuator, is by itself generally unsuited for accurately positioning.

The driver for the short-stroke actuator supplies a current within a large dynamic range. Usually a controller for the driver includes a feed-back loop that includes a current sensor unit configured to measure a momentary value of the current. The current to be supplied may vary from a very small value e.g. in the range of a fraction of an ampere during the scanning phase to a very high current of tens of amperes during acceleration. The current sensor unit should have a current sensor that is capable of measuring also the highest currents occurring during acceleration. As the noise generated by of a current sensor is in practice a percentage of its maximum measurement range, the signal to noise ratio of the current measurement is relatively low when measuring the relatively low currents during the scanning phase. The noise of the current sensor unit may contribute to noise in the motor current, because it is used in a feedback configuration. The resulting motor current may result in positioning errors that are large compared to the specifications desired for a lithographic machine. This applies in particular to EUV-RS (extreme UV) systems.

### SUMMARY

An aspect of the invention provides an improved drive system and method for driving an electric actuator.

Another aspect of the invention provides an improved lithographic apparatus.

According to an aspect of the invention, a drive system is configured to controllably drive an electric actuator. The drive system includes a current sensor system configured to sense a current conducted by the electric actuator, the current sensor system including at least a first and a second current sensor, having a mutually different sensitivity for the current to be sensed; a driver configured to electrically drive the electric actuator based on an output signal of the current sensor system, the driver including a current sensor controller configured to control an extent to which each of the at least first and second current sensors determines the output signal of the current sensor system.

The drive system includes at least a first and a second current sensor that have a mutually different value for the upper range for the current to be sensed. The drive system further includes a current sensor controller to control an extent to which each of the current sensors determines the output signal of the current sensor system. The first current sensor may have a range with a maximum m1 equal to a value of the actuator current typical for the acceleration mode, e.g. the maximum current expected during acceleration. The second current sensor may have a range with a maximum m2 that is lower than that of the first current sensor.

In an embodiment the current sensor controller includes a selector that is configured to select the current sensor having the lowest sensitivity if a value of the current is estimated higher than a threshold value, and to select the current sensor having the highest sensitivity if the value of the cuforwardrrent is estimated lower than a threshold value. The threshold value is for example the maximum m2. Alternatively a threshold value lower, e.g. 10% lower than the maximum m2 can be chosen, to take into account tolerances in the drive system.

The selector is configured to select the second current sensor if the current supplied to the actuator comes within the range of the second sensor. As the measurement range of this second current sensor has a lower maximum, a lower absolute noise level is achieved even if the second current sensor has the same relative signal to noise level at the maximum of its measurement range. If the current supplied exceeds the range of the second sensor, e.g. during acceleration, the selection device is configured to select the first current sensor. A substantial improvement in the signal to noise ratio is already achieved if the ratio m1 m2 is greater or equal than 2. Preferably the ratio m1 m2 is at least 10.

Although a current sensor system with two current sensors suffices, the current sensor system may have more than two current sensors. In that case, a maximum measurement accuracy is obtained if the selection device selects the current sensor with the measurement range having the lowest maximum higher than the current to be measured.

Instead of selecting only one of the sensor signals as the output signal of the current sensor, the current sensors may jointly contribute to the output signal of the current sensor system. In that case, the current sensor control device determines a weight factor for each of the current sensors with which the current sensors respectively contribute to the output signal of the current sensor system. The value of the weight factors depends on the magnitude of the current that is determined, wherein the weight factor for the current sensor having the highest sensitivity is higher than the weight factor for the current sensor with the lowest sensitivity if a magnitude of the current is determined lower than a threshold value. If a magnitude of the current is determined higher than a threshold value then the weight factor for the current sensor having the highest sensitivity is lower than the weight factor for the current sensor with the lowest sensitivity. In a particular embodiment the weight factor for the current sensor with the highest sensitivity is a decreasing function of the determined current. Therein, the weight factor for that current sensor decreases to a value 0 until the determined current reaches a threshold value and remains 0 for a determined current higher than the threshold. The weight-factor for the current sensor with the lowest sensitivity is an increasing function of the determined current, that increases from a value 0 until the determined current reaches a threshold value and subsequently remains constant for higher determined values of the current. The threshold value is for example the maximum m2 for the sensing range of the current sensor having the highest sensitivity. Alternatively a threshold value lower, e.g. 10% lower than the maximum m2 can be chosen, to take into account tolerances in the drive system.

Several options are possible to determine a magnitude of the current. In an embodiment of the drive system, operation of the current sensor controller is controlled by a magnitude indication signal obtained from at least one of the current sensors. This has the benefit that the selection device is controlled on the basis of a signal that is already present. The magnitude indication signal may be provided by the current sensor having the measurement range with the highest maximum. Although the measurement accuracy of this current sensor is relatively low, it is still sufficient to decide which current sensor has the optimum measurement range under the circumstances. Alternatively the current sensor with the lowest maximum may be used. If the current approaches the maximum of the range of that sensor, this can be used as an indication that another current sensor having a measurement range with a higher maximum should be used. On its turn this other current sensor may provide an overload signal that initiates selection of a further current sensor.

Alternatively, a control signal for the current sensor control device may be provided by an external source, e.g. by a master controller as is set out in more detail below.

In an embodiment, the drive system includes a position sensor that provides a first position signal indicative of a position of an object that is displaced by the actuator. Therein, a first comparator is configured to provide a difference signal indicative of a difference between a position indicated by the first position signal and a desired position of the object indicated by a first setpoint signal. A first controller is configured to control the drive unit in dependence of the difference signal. In this case, the current control loop is controlled by the position control loop. The current control loop assists in rapidly and accurately achieving the target set by the position control loop.

In an embodiment, an output signal of a feedforward filter is superposed to an output signal of the first controller. The first feed-forward controller takes into account the dynamic properties of the actuator and may adapt the control circuit to predetermined resonance frequencies, a desired bandwidth, or any other characteristic or specification. Accordingly the position feedback loop merely has to compensate for unpredictable errors.

In an embodiment, a drive system is arranged to drive a further or additional actuator. Therein, the further or additional actuator is configured to position the actuator. The drive system includes a second comparator that is configured to provide a second difference signal indicative of a difference between the first position signal and a second displacement signal indicative of the displacement caused by the long-stroke actuator. The drive system includes a second drive unit configured to drive the long-stroke actuator and a second controller configured to control the second drive unit in dependence of the second difference signal. The long-stroke actuator allows for a positioning of the object in a wide position range. The short-stroke actuator is configured to provide an accurate positioning. In this embodiment, the position feed-back loop of the short-stroke actuator is configured to position the object at the desired setpoint, while the difference between the fixed setpoint and the achieved position of the object with respect to the long stroke actuator is used to control the position feedback loop for the long-stroke actuator. In an embodiment, the second controller is coupled to the second comparator. A signal from a second feed-forward controller may be superposed to the output signal of the second controller. This second feed-forward controller takes into account dynamic properties of the long-stroke actuator.

In an embodiment, the drive system includes a master control unit that includes a setpoint generator configured to provide a signal indicative for a desired position of an object to be positioned by the actuator, and to provide a control signal to the current sensor control device. As the master control unit has the information about the planned position of the object, and therewith also has information about the expected accelerations it can predict the current to be delivered to the actuator(s). Accordingly, it can provide a control signal to the current sensor control device to determine which current sensor is the most appropriate or how the output signals of the current sensors should be weighted.

In an aspect of the invention, there is provided a lithographic projection apparatus including a radiation system configured to provide a beam of radiation; a patterning device support configured to support a patterning device, the patterning device serving to pattern the beam of radiation according to a desired pattern to form a patterned beam of radiation; a substrate support configured to hold a substrate; a projection system configured to project the patterned beam onto a target portion of the substrate; an electric actuator configured to position at least one of the supports; and a drive system configured to controllably drive the electric actuator, the drive system including a current sensor system configured to sense a current conducted by the electric actuator, the current sensor system including at least a first and a second current sensor, having a mutually different sensitivity for the current to be sensed; and a driver configured to electrically drive the electric actuator based on an output signal of the current sensor system, the driver including a current sensor controller configured to control an extent to which each of the at least first and second current sensors determines the output signal of the current sensor system.

In a lithographic projection apparatus, high accuracies are desired for positioning the substrate with respect to the pattern, while on the other hand positioning should take place at a high speed. A drive system according to an embodiment of the present invention enables this.

The lithographic projection apparatus may include an actuator for the substrate table and/or for the support structure and/or for other components of the lithographic apparatus. Positioning of the components may be carried out by using a combination of a long-stroke actuator and a short-stroke actuator instead of by a single actuator. Each of the actuators may be controlled by a drive system according to an embodiment of the invention. Multiple drive systems may be coordinated by a shared master controller.

According to a further aspect of the invention, there is provided a method for controllably driving an electric actuator, the method including determining a magnitude of a current provided to the electric actuator; and electrically driving the actuator more in dependence of an output signal of a first sensor having a relatively high current sensitivity if the determined magnitude for the current is relatively low and electrically driving the actuator more in dependence on an output signal of a second sensor having a relatively low current sensitivity if the determined magnitude for the current is relatively high.

### BRIEF DESCRIPTION OF THE DRAWINGS

These and other aspects of the invention are described with reference to the drawings. Therein:

FIG. 1 illustrates a lithographic apparatus according to an embodiment of the present invention,

FIG. 2 illustrates an actuator assembly configured to position a component of the lithographic apparatus in accordance with an embodiment of the invention;

FIG. 3 schematically illustrates a drive system for the actuator assembly in accordance with an embodiment of the invention;

FIG. 4 illustrates a module of the drive system in more detail in accordance with an embodiment of the invention;

FIG. 4A illustrates part of the module of FIG. 4 in accordance with an embodiment of the invention;

FIG. 5 illustrates a part of the module in accordance with an embodiment of the invention

FIG. 5A illustrates an alternative component for the part in FIG. 5 in accordance with an embodiment of the invention;

FIG. 5B illustrates a further alternative component for the part in FIG. 5 in accordance with an embodiment of the invention; and

FIG. 6 shows an alternative module for a drive system in accordance with an embodiment of the invention.

### DETAILED DESCRIPTION

In the following detailed description numerous specific details are set forth in order to provide a thorough understanding of various embodiments of the present invention. However, it will be appreciated by one skilled in the art that embodiments of the present invention may be practiced without these specific details. In other instances, well known methods, procedures, and components have not been described in detail so as not to obscure various aspects of the present invention. Various embodiments of the invention are described more fully hereinafter with reference to the accompanying drawings, in which embodiments of the invention are shown. The invention may, however, be embodied in many different forms and should not be construed as limited to the embodiments set forth herein. Rather, these embodiments are provided so that this disclosure will be thorough and complete, and will fully convey the scope of the invention to those skilled in the art.

In the drawings, the size and relative sizes of layers and regions may be exaggerated for clarity. Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. Thus, the regions illustrated in the figures are schematic in nature and their shapes are not intended to illustrate the actual shape of a region of a device and are not intended to limit the scope of the invention.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

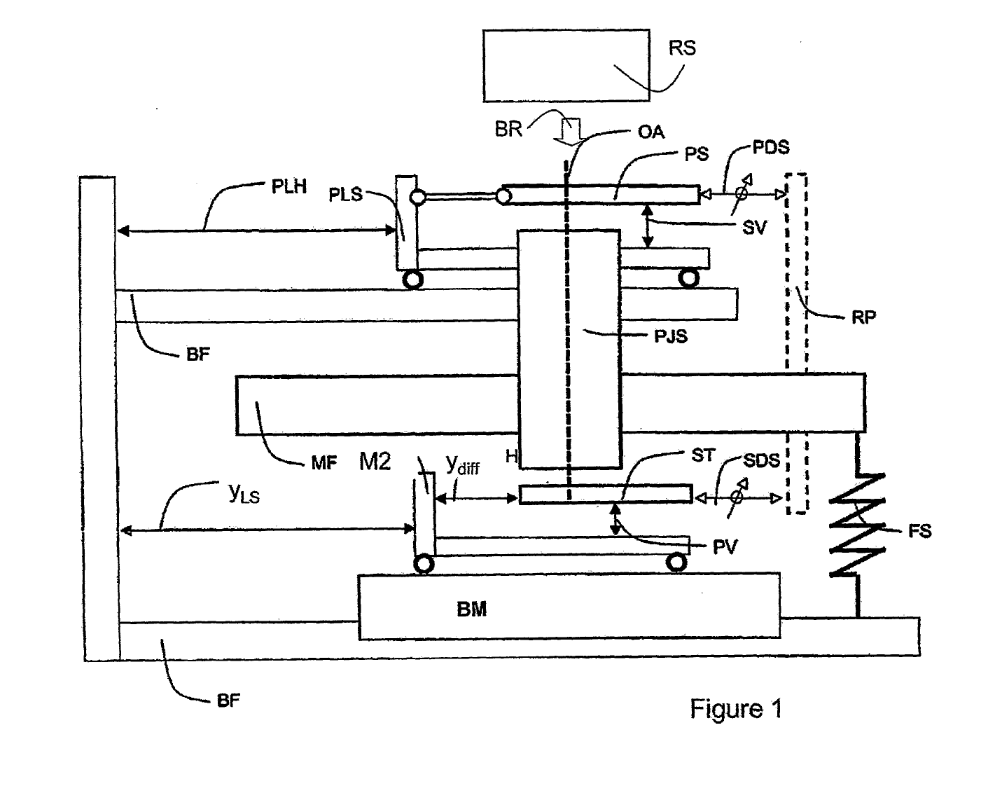

FIG. 1 illustrates a lithographic apparatus according to an embodiment of the present invention having a base frame BF, a projection system PJS coupled to a metrology frame MF, which is isolated from the BF by a soft suspension system FS (e.g. air-mounts or very soft mechanical strings). A reference plane RP is indicated by a dashed line. The reference plane RP is parallel to an optical axis OA of the projection system PJS, but may also be selected differently.

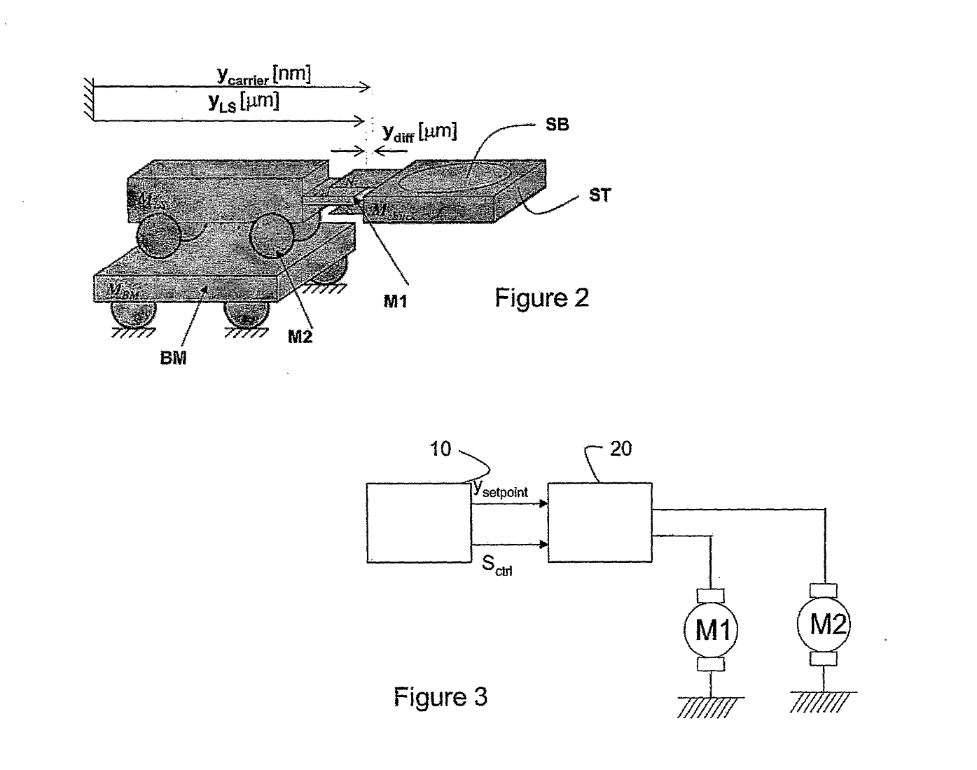

A support structure (patterning device support or pattern support) PS is positioned at a first end of the optical axis OA and a substrate table or substrate support ST is positioned at the other end of the optical axis OA. During operation a patterning device (not shown) is positioned on the pattern support PS and a substrate is positioned on the substrate table ST. A radiation beam BR is generated by a radiation source RS and guided through the patterning means along an optical path, here an optical axis OA to the substrate (SB in FIG. 2) on the substrate table ST. It is not necessary that the optical path is a straight line as shown in the example of FIG. 1. U.S. Pat. No. 6,867,846, for example, describes a EUV-lithographic apparatus, wherein the radiation beam is guided by reflection along an optical path including multiple straight segments. Alternatively the optical system may include optical elements wherein the radiation beam follows a curved trajectory. The patterning device serves to pattern the projection beam BR according to a desired pattern. The projection system PJS subsequently images the patterned beam onto a target portion of the substrate. For a correct projection on the substrate, it is desirable to align the patterning device, the projection system PJS and the substrate.

The depicted apparatus can be used in two different modes:

In step mode, the pattern support PS is kept essentially stationary, and an entire patterning device image is projected at once (i.e. a single “flash”) onto a target portion of the substrate. The substrate table ST is then shifted in the x and/or y directions so that a different target portion can be irradiated by the patterned beam.

In scan mode, essentially the same scenario applies, except that a given target portion is not exposed in a single “flash”. Instead, the pattern support is movable in a given direction (the so-called “scan direction”, e.g. the y direction) with a speed v, so that the radiation beam RB is caused to scan over a mask image; concurrently, the substrate table ST is simultaneously moved in the same or opposite direction at a speed V=Mv, in which M is the magnification of the projection system PJS (typically, ¦M¦=[¼] or [⅕]). In this manner, a relatively large target portion of the substrate can be exposed, without having to compromise on resolution.

As shown schematically in FIG. 2, the lithographic apparatus includes an electric actuator M1 configured to position at least one of the support structure or the substrate table ST. In the embodiment shown the substrate table is provided with an actuator assembly that includes a short-stroke actuator M1 and a long-stroke actuator M2.

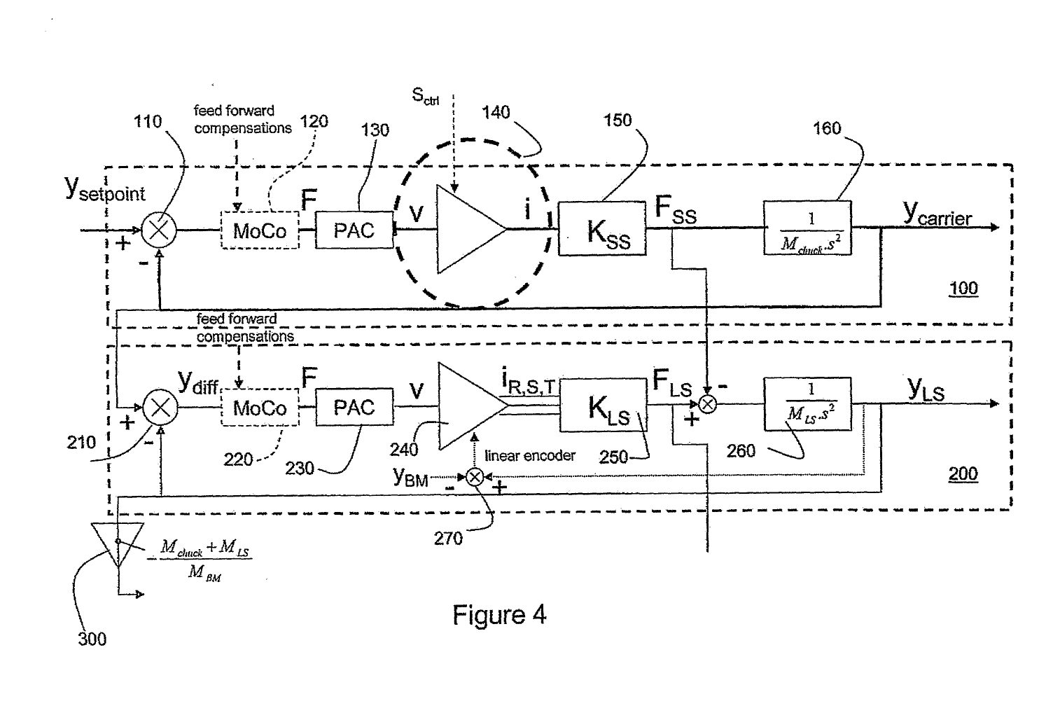

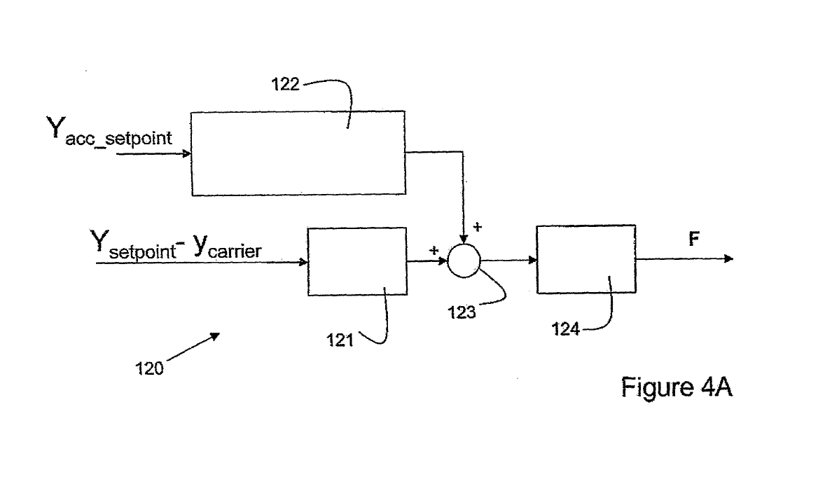

As shown in more detail in FIG. 3, the lithographic apparatus further includes a drive system 10, 20 configured to drive the short-stroke actuator M1 and the long-stroke actuator M2. Suitable actuators for use as short-stroke and long-stroke actuators are known to the skilled person. The short-stroke actuator is for example described in U.S. Pub. No. 2003-155821. The drive system shown in FIG. 3 includes a master control unit or master controller 10. The master control unit or controller 10 includes a setpoint generator configured to provide a signal indicated for a desired position yₛₑₜₚₒᵢₙₜ of an object to be positioned, here the substrate table ST as a function of time. The master control unit also provides a control signal S_{ctrl}. The master control unit provides these signals to a controller unit 20 that is configured to control the actuator assembly M1, M2 in order to position the substrate table ST as close as possible to the desired setpoint. The controller unit 20 is shown in more detail in FIG. 4.

As shown in FIG. 4, the controller 20 includes a first control module 100 configured to control the short-stroke actuator M1 and a second control module 200 configured to control the long-stroke actuator M2. The long-stroke actuator M2 provides for a displacement y_{LS} over a relatively large range. The short-stroke actuator provides for an accurate displacement y_{diff} over a relatively short range The first control module 100 will now be described in more detail.

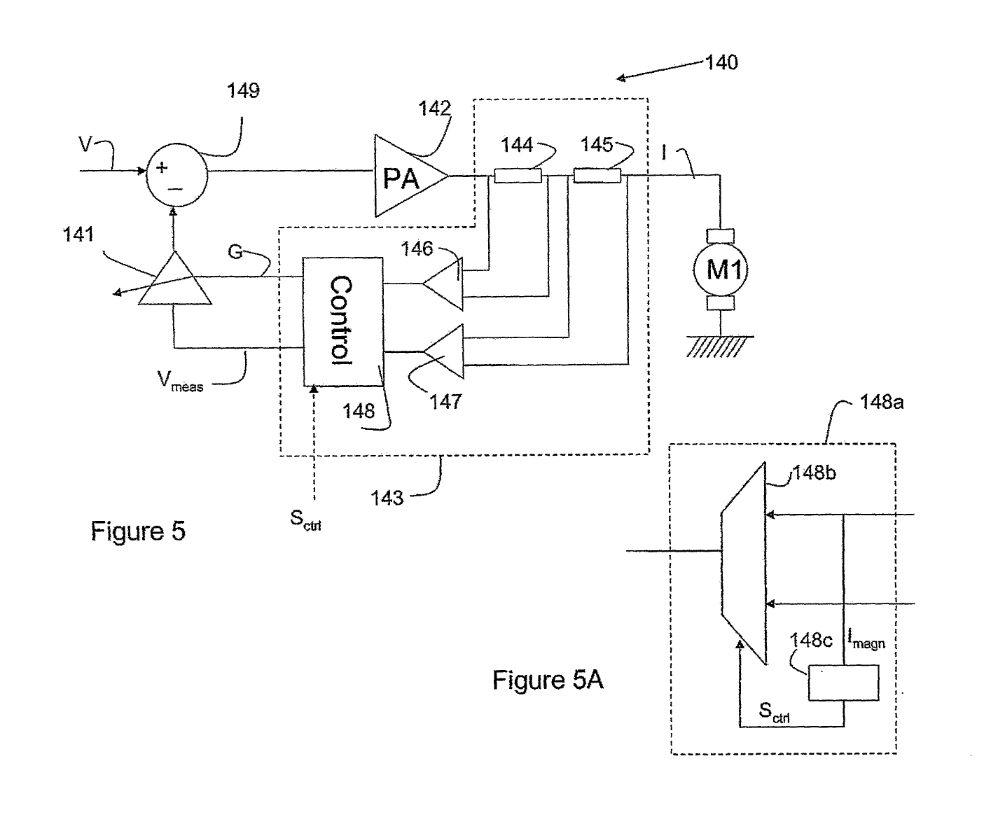

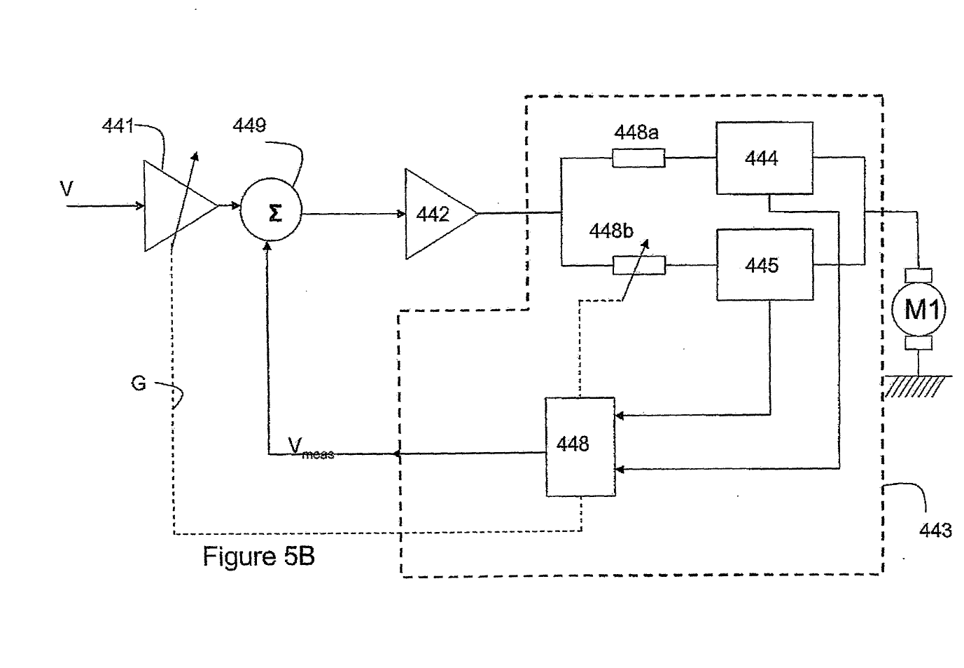

The short stroke actuator 100 includes a comparator 110 configured to compare a value for a desired position yₛₑₜₚₒᵢₙₜ with a value indicative for the actual position y_{carrier} of the substrate. A difference signal is provided by the comparator to an amplifier 130. The difference signal is processed by a controller 120. As shown in more detail in FIG. 4A, the controller 120 includes a feedback controller, e.g. a PID-controller 121. In the embodiment shown the controller 120 further includes a feed forward filter 122 that processes a signal V_{acc}_{_{—}}ₛₑₜₚₒᵢₙₜ indicative for a desired acceleration of the substrate table ST with the substrate SB. The feed-forward filter 122 calculates the required force to be exerted by the actuator M1 to achieve the desired acceleration, taking into account the total of the mass of the substrate table ST, the substrate SB thereon, and the mass of the moving parts of the first actuator M1. An adder 123 adds the output signals of the feedback controller 121 and the feed forward filter 122. Additionally a post-filter 124 may be provided, e.g. to prevent that resonance frequencies in the system are excited by the signal introduced via the feedforward filter. The controller 130 provides a control signal V to actuator driver 140, which provides the substrate short stroke actuator M1 with a driving current I. The actuator drive 140 may further receive the control signal S_{ctrl} from the master control unit or master controller 10. This signal S_{ctrl} is indicative for the expected range of the current to be delivered by the actuator driver 140. The actuator driver 140 is described in more detail with reference to FIG. 5. Block 150 represents the conversion of the current provided to the substrate short stroke actuator M1 into a force F_{SS}. Block 160 represents the dynamic model of the chuck, i.e. the carrier ST with the substrate SB, that indicates how the chuck responds to the force F_{SS} exerted thereon by the substrate short stroke actuator M1. The signal y_{carrier} representative of the position of the chuck with respect to the base frame that is fed back to the comparator 110 is provided by a position sensor SDS. The position sensor may be based on an interferometer system or an encoder system. An encoder system includes a grating and an optical encoder detecting the grating.

The signal y_{carrier} is further provided to the substrate long stroke actuator 200, and compared by a comparator 210 with a signal Y_{LS}, representative of the position determined by the long-stroke actuator M2, to calculate a difference signal Y_{diff}. The difference signal is provided via a controller 220 to an amplifier 230. The amplifier 230 provides a control voltage to a driver 240 configured to drive the substrate long stroke actuator 240. The controller 220 may have the same architecture as the controller 120. The setpoint signal indicative of a desired acceleration to be provided to the feedforward filter in the controller 220 is basically the same as the setpoint signal Y_{acc}_{_{—}}ₛₑₜₚₒᵢₙₜ provided to the controller 120, as the second actuator M2 follows the movement of the first actuator M1. The feedforward filter of the controller calculates the desired force to achieve this acceleration, taking into account the mass of the substrate table ST with the substrate SB and the mass of the actuator M1, as well as the mass of the moving parts of actuator M2. In this case, the driver 240 includes a commutator that is configured to provide a set of driving currents i_{R,S,T} to the substrate long stroke actuator M2, 250. Block 250 represents the response of the substrate long stroke actuator M2 into a force F_{LS}. Block 260 represents the conversion of the force F_{LS} into a displacement Y_{LS} of the long-stroke actuator M2. The signal Y_{LS} is further provided to a controller 300 to position the balancing mass BM. Alternatively the balancing mass may be suspended in a damped spring system.

FIG. 5 shows the actuator driver 140 for the short-stroke actuator M1 according to an embodiment of the invention. As shown in FIG. 5, the actuator drive includes a current sensing unit or sensor system 143 configured to sense a current I conducted by the actuator M1. The actuator driver 140 further includes a drive unit or driver 142 configured to electrically drive the actuator M1 in dependence of an output signal Vₘₑₐₛ of the current sensing unit or sensor system 143. The current sensing unit or sensor system 143 includes at least a first current sensor 144,146 and a second current sensor 145, 147. The first and the second current sensor have a mutually different sensitivity for the current to be sensed. The first current sensor 144, 145 has a relatively low sensitivity and has a current measuring range with a maximum m1. The second current sensor 146, 147 has a relatively high sensitivity and has a current measuring range with a relatively small maximum m2, i.e. a maximum m2 smaller than the maximum m1. The drive system includes a current sensor control device or current sensor controller 148 that is configured to control an extent to which each of the current sensors determines the output signal Vₘₑₐₛ of the current sensing unit or sensor system 143.

In the embodiment shown, the current sensor control device 148 is, or includes, a selection device or selector that is configured to enable one of the first or the second current sensor to provide the output signal Vₘₑₐₛ of the current sensing unit or sensor system 143. The drive unit includes a fixed power amplifier 142 that provides the driving current for the first actuator M1. The output signal of the current sensor Vmeas is amplified by a variable gain amplifier 141 that is controlled by a gain control signal G also provided by selection device 148. The output of the amplifier 149 is provided to the adder 149. The variable gain makes it possible to compensate for a mutually different gain value of the current sensors 144, 146 and 145, 147. Alternatively, a difference in gain between the current sensor 144, 146 on the one hand and the current sensor 145, 147 on the other hand may be avoided by properly selecting the amplification factors of the difference amplifiers 146, 147. In this way, the total gain of the current loop is maintained constant. As shown in FIG. 5, the current sensors may have the form of a series resistor 144, 145 in combination with a difference amplifier 146, 147 that provides a difference signal indicative for the measured voltage drop over the respective series resistor. However other current sensors, e.g. Hall effect sensors, are suitable too. As shown in FIG. 5, the selection of the selection device or selector 148 is determined by the control signal S_{ctrl} provided by the master control unit 10.

In an alternative embodiment, shown in FIG. 5A, the operation of the selection device or selector 148a is controlled by a magnitude indication signal I_{magn} obtained from at least one of the current sensors. The selection device or selector 148a includes a multiplexer 148b that enables a first one of the current sensors if the magnitude indication signal I_{magn} indicates that the current conducted by the actuator M1 exceeds a first value. The selection device or selector 148a enables a second one of the current sensors if the magnitude indication signal I_{magn} indicates that the current conducted by the actuator M1 drops below a second value. The magnitude indication signal I_{magn} may be provided by the current sensor with the current sensing range having the highest maximum. This signal I_{magn} may be provided to a threshold device 148c that provides a binary signal that controls the multiplexer 148b. Alternatively, for example, in case two current sensors are present, the current sensor having the range with the lowest maximum may provide an overflow signal, indicating whether its current sensing range is exceeded. This overflow signal may be used to control the multiplexer 148b.

FIG. 5B shows another embodiment. Parts therein corresponding to those in FIG. 5 have reference number that is 300 higher. In FIG. 5B, the current provided by the driver 442 is split into a first and second current. The first current passes through a first branch with fixed impedance 448a and current sensor 444 and the second current passes through a second branch with variable impedance 448b and current sensor 445. A current sensor control device or current sensor controller 448 determines a weight factor for each of the current sensors with which the current sensors respectively contribute to the output signal of the current sensing unit or sensor system 443. The value of the weight factors depends on the magnitude of the current that is determined. The impedance of the variable impedance 448b is accordingly controlled. At a relatively low current, the variable impedance 448b is substantially smaller than that of impedance 448a, so that the current substantially passes through the second current sensor 445, having the relatively small measurement range. Consequently, the weight factor for the current sensor having the highest sensitivity then is higher than the weight factor for the current sensor with the lowest sensitivity.

When the current increases, the current sensor control device 448 substantially increases the variable impedance 448b, so that the contribution of the second current sensor 445, having the relatively small measurement range, is reduced. Consequently a larger part of the current then flows through the branch with current sensor 444 so that the contribution of the first current sensor 444 to the output signal Vₘₑₐₛ is increased. Accordingly, the weight factor for the current sensor having the highest sensitivity then is lower than the weight factor for the current sensor with the lowest sensitivity.

In an embodiment, the weight factor for the current sensor 445 with the highest sensitivity is a decreasing function of the determined current, that decreases to a value 0 until the determined current reaches a threshold value and remains 0 for a determined current higher than the threshold. The weight-factor for the current sensor 444 with the lowest sensitivity is an increasing function of the determined current, that increases from a value 0 until the determined current reaches a threshold value and subsequently remains constant for higher determined values of the current. This is carried out in that the value for the impedance 448b is controlled from a value substantially smaller than that of the impedance 448a, e.g. 0 ohm, to a value substantially larger than the value of the impedance 448a, e.g. 10 times larger, when the current increases from 0 to the threshold value. Above the threshold value, the impedance of 448a may further increase or may remain constant, so that the weight factor for the second current sensor 445 remains substantially 0.

More than one branch may include a variable impedance. More than two branches may be present to select between a plurality of current sensors. In this case, a difference in trans-impedance of the current sensors 444, 445 is compensated by a variable gain amplifier 441. The gain of this amplifier 441 is varied with a factor that corresponds to the ratio between the trans-impedances of the current sensors. Accordingly if the second current sensor 445 has a trans-impedance that is a factor p higher than that of the first current sensor, then the gain of the variable gain amplifier is set a factor p higher if the second current sensor is selected. The output of the amplifier 441 is added to the output signal Vₘₑₐₛ with adder 449.

The embodiment described above was compared to the conventional embodiment wherein a single current sensor is used. While the noise introduced in the current loop contributed with 184 nm to the total positioning inaccuracy in the conventional lithographic apparatus, the contribution due to the current loop is reduced to below 300 pm in the lithographic apparatus according to an embodiment of the invention, which is a substantial improvement.

In the embodiment described above, the substrate table ST is positioned with the actuator assembly M1, M2. In an alternative embodiment the pattern support PS is positioned by a long-stroke actuator PLS at position PLH. The position is measured with sensor PDS. The substrate table ST is provided with a short stroke actuator. The substrate table ST and thus the substrate may be accurately positioned in the first degree of freedom with respect to the reference plane RP. Since the pattern support PS is not provided with a short stroke actuator, the patterning device may be positioned in the first degree of freedom with a relatively low positioning accuracy with respect to the reference plane RP. A positioning error resulting from the relatively low positioning accuracy may however be compensated by positioning the substrate corresponding to the actual position of the patterning device.

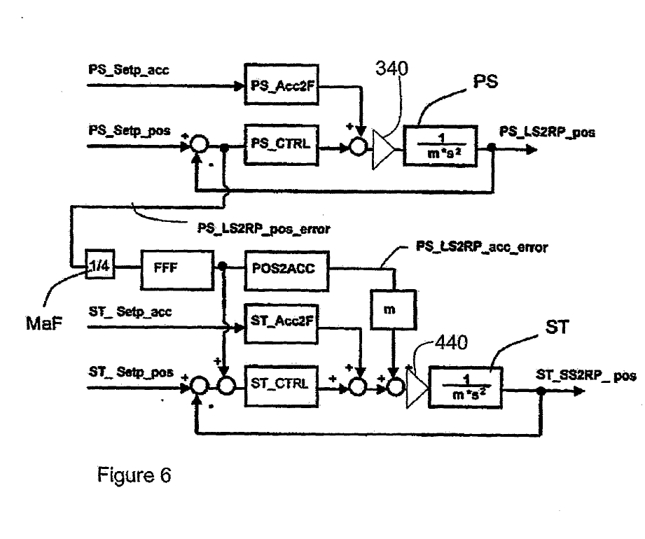

FIG. 6 shows a control system for an actuator assembly configured to move the substrate table ST. The actuator assembly includes a substrate short stroke actuator configured to move the substrate in the first degree of freedom over a relatively short distance y_{diff}. More actuators may be provided, for example to move the substrate table ST in more than one degree of freedom PV. A substrate position determination system SDS may be provided to determine a position of the substrate with respect to the reference plane RP. Examples of position determination system include an interferometer system or an encoder system. An encoder system includes a grating and an optical encoder detecting the grating.

An actuator assembly configured to move the pattern support PS includes a pattern long stroke actuator PLS configured to move the patterning device in the first degree of freedom over a relatively large distance PLH. More actuators may be provided, for example to move the pattern support PS in more than one degree of freedom SV. A pattern position determination system PDS, such as an interferometer system or an encoder system, is provided to determine a position of the patterning device with respect to the reference plane RP.

To position the pattern support PS, a desired pattern support position set point PS_Setp_pos and a desired pattern support acceleration set point PS_Setp_acc are input into control circuitry of the control system. A first filter PS_Acc2F is configured to filter the desired acceleration PS_Setp_acc to a desired force. From the desired position PS_Setp_pos, an actual position PS_LS2RP_pos, determined by the position determination system (PDS in FIG. 1), is subtracted, resulting in a position error PS_LS2RP_pos_error with respect to the reference point or plane. The position error PS_LS2RP_pos_error is input to a controller PS_CTRL, such as a PID controller, to obtain a suitable force for moving the pattern support PS to the desired position PS_Setp_pos. The sum of the control signals provided by the controller PS_CTRL and the first filter PS_Acc2F is provided to the actuator driver 340 that provides the driving current to the pattern support actuator. The actuator driver 340 is an actuator driver according to an embodiment of the present invention, e.g. as described with reference to FIGS. 5, 5A and 5B. The mechanical characteristics of the pattern support PS are shown as a filter for the generated forces outputting the actual position of the pattern support PS. As mentioned above, the pattern support PS is not accurately positioned, since a short stroke actuator is omitted. To compensate for the resulting positioning error, the position error PS_LS2RP_pos_error is supplied to the control circuitry for controlling the movement of the substrate table ST.

The substrate table ST may be controlled using similar control circuitry, including a second filter ST_Acc2F for filtering a desired acceleration ST_Setp_acc to a desired force added to a force output by a controller ST_CTRL which controller ST_CTRL receives a signal corresponding to a desired position ST_Setp_pos and an actual position ST_SS2RP_pos. The substrate table ST is further controlled by a force generated by a feed-forward circuit receiving the positioning error PS_LS2RP_pos_error of the pattern support PS. This positioning error PS_LS2RP_pos_error is added to the position set point ST_Setp_pos after filtering by a magnification filter MaF and possibly another feed-forward filter FFF. The feed-forward circuit may, for example adapt the control circuit to predetermined resonance frequencies, a desired bandwidth, or any other characteristic or specification. The feed-forward filter FFF may further include a time delay filter configured to compensate a time delay occurring in the time differentiation filter POS2ACC when determining the acceleration error PS_LS2RP_acc_error from the positioning error PS_LS2RP_pos_error. The control circuit may as well be provided with a prediction circuit, e.g. as disclosed in European Patent application No. 1 265 104, incorporated herein by reference.

Further, the positioning error PS_LS2RP_pos_error is fed to a time differentiation filter POS2ACC for differentiating the positioning error PS_LS2RP_pos_error twice with respect to time thereby determining a pattern support acceleration error PS_LS2RP_acc_error. Filtering this acceleration error PS_LS2RP_acc_error with the mass m of the substrate table ST determines a suitable force to be exerted on the substrate table ST for feed-forward compensating the acceleration error PS_LS2RP_acc_error. Thus, the feed-forward of the positioning error PS_LS2RP_pos_error to the control circuit of the substrate table ST enables to compensate for a positioning error PS_LS2RP_pos-error and/or an acceleration error of the pattern support PS_LS2RP_acc_error by adjusting the desired position and/or the desired acceleration of the substrate table ST. The control signals generated by time differentiation filter POS2ACC, second filter ST_Acc2F and controller ST_CTRL are superposed and provided to the actuator driver 440 that provides the driving current to the short-stroke substrate support actuator. Second filter ST_Acc2F is provided with acceleration position setpoint ST_Setp_pos. The actuator driver 440 is an actuator driver according to an embodiment of the present invention, e.g. as described with reference to FIGS. 5, 5A and 5B.

As mentioned above, the feed-forward circuit may be provided with a magnification filter MaF. The magnification filter MaF may compensate a magnification of the projection system, since such a magnification may result in a different desired position and speed for patterning device and substrate. For example, with a magnification of [¼] of the projection system, a displacement of the patterning device with respect to the projection system, may be compensated by a displacement of the substrate [¼] times as large as the displacement of the patterning device with respect to the projection system. Therefore, also the positioning error PS_LS2RP_Pos_error needs to be corrected for this magnification.

In the claims the word “comprising” does not exclude other elements or steps, and the indefinite article “a” or “an” does not exclude a plurality. A single component or other unit may fulfill the functions of several items recited in the claims. The mere fact that certain measures are recited in mutually different claims does not indicate that a combination of these measures cannot be used to advantage. Any reference signs in the claims should not be construed as limiting the scope.

1. A drive system configured to controllably drive an electric actuator, the drive system comprising:
a current sensor system configured to sense a current conducted by the electric actuator, the current sensor system comprising at least a first and a second current sensor that have a mutually different sensitivity for the current to be sensed; and
a driver configured to electrically drive the electric actuator based on an output signal of the current sensor system, the driver comprising a current sensor controller configured to control an extent to which each of the at least first and second current sensors determines the output signal of the current sensor system.

2. A drive system according to claim 1, wherein the current sensor controller includes a selector that is configured to select the current sensor of the current sensor system having the lowest sensitivity if a value of the current is higher than a threshold value, and to select the current sensor having the highest sensitivity if the value of the current is lower than a threshold value.

3. A drive system according to claim 1, wherein the current sensor controller is configured to determine a weight factor for each of the first and second current sensors with which the first and second current sensors respectively contribute to the output signal of the current sensor system, a value of the weight factor depending on a magnitude of the current that is determined, wherein the weight factor for the current sensor having the highest sensitivity is higher than the weight factor for the current sensor with the lowest sensitivity if a magnitude of the current is lower than a threshold value, and wherein the weight factor for the current sensor having the highest sensitivity is lower than the weight factor for the current sensor with the lowest sensitivity if a magnitude of the current is higher than a threshold value.

4. A drive system according to claim 3, wherein the weight factor for the current sensor with the highest sensitivity is a decreasing function of the determined current, that decreases to a value 0 until the determined current reaches a threshold value and remains 0 for a determined current higher than the threshold, and wherein the weight-factor for the current sensor with the lowest sensitivity is an increasing function of the determined current, that increases from a value 0 until the determined current reaches a threshold value and subsequently remains constant for higher determined values of the current.

5. A drive system according to claim 1, comprising a variable gain amplifier configured to compensate a difference in trans-impedance of the current sensors.

6. A drive system according to claim 2, wherein operation of the selector is controlled by a magnitude indication signal obtained from the at least one of the first and second current sensors, wherein the selector is configured to enable a first one of the first and second current sensors if the magnitude indication signal indicates that the current conducted by the electric actuator exceeds a first value, and the selector is configured to enable a second one of the current sensors if the magnitude indication signal indicates that the current conducted by the actuator drops below a second value.

7. A drive system according to claim 1, comprising a position sensor configured to provide a first position signal indicative of a position of an object that is displaced by the electric actuator, a first comparator configured to provide a difference signal indicative of a difference between a position indicated by the first position signal and a desired position of the object indicated by a first setpoint signal, and a controller configured to control the driver in dependence of the difference signal.

8. A drive system according to claim 7, further including a first feed-forward controller.

9. A drive system according to claim 7, wherein the drive system is further configured to drive an additional electric actuator that is configured to position the electric actuator and wherein the driver comprises a second comparator that is configured to provide a second difference signal indicative of a difference between the first position signal and a second displacement signal indicative of the displacement caused by the additional electric actuator, an additional driver configured to drive the additional electric actuator and an additional controller configured to control the additional driver in dependence of the second difference signal.

10. A drive system according to claim 9, further including a second feed-forward controller.

11. A drive system according to claim 1, comprising a master controller that comprises a setpoint generator configured to provide a signal indicative of a desired position of an object to be positioned by the actuator, and to provide a control signal to the control device.

12. A drive system according to claim 1, wherein the current provided by the driver is split into a first and a second current, wherein the first current passes through a first branch with fixed impedance and the first current sensor and the second current passes through a second branch with variable impedance and the second current sensor, and wherein the controller is configured to control the value of the variable impedance.

13. A lithographic projection apparatus comprising:
a radiation system configured to provide a beam of radiation;
a patterning device support configured to support a patterning device, the patterning device serving to pattern the beam of radiation according to a desired pattern to form a patterned beam of radiation;
a substrate support configured to hold a substrate;
a projection system configured to project the patterned beam onto a target portion of the substrate;
an electric actuator configured to position at least one of the supports; and
a drive system configured to controllably drive the electric actuator, the drive system comprising
a current sensor system configured to sense a current conducted by the electric actuator, the current sensor system comprising at least a first and a second current sensor, having a mutually different sensitivity for the current to be sensed;
a driver configured to electrically drive the electric actuator based on an output signal of the current sensor system, the driver comprising a current sensor controller configured to control an extent to which each of the at least first and second current sensors determines the output signal of the current sensor system.

14. A method for controllably driving an electric actuator, the method comprising:
determining a magnitude of a current provided to the electric actuator; and
electrically driving the actuator more in dependence of an output signal of a first sensor having a relatively high current sensitivity if the determined magnitude for the current is relatively low and electrically driving the actuator more in dependence on an output signal of a second sensor having a relatively low current sensitivity if the determined magnitude for the current is relatively high.
